(19) United States
(12) Patent Application Publication
(10) Pub. No.: US 2023/0074954 A1
(43) Pub. Date: Mar. 9, 2023

(54) Laser Treatment Device and Procedure for Laser Treatment

(71) Applicant: NETALUX NV, Paal (BE)

(72) Inventors: Pieter Cretskens, Paal (BE); Emmanuel Flaam, Paal (BE)

(21) Appl. No.: 17/794,827

(22) PCT Filed: Jan. 26, 2021
(86) PCT No.: PCT/IB2021/050577

§ 371 Date: Jul. 22, 2022

(30) Foreign Application Priority Data
Jan. 27, 2020 (BE) 20205050

(51) Int. Cl. B08B 7/00; B23K 26/00; B23K 26/04; B23K 26/082; B23K 26/14; B23K 26/36; B08B 13/00

(52) U.S. Cl. CPC B08B 7/0042; B23K 26/0096; B23K 26/04; B23K 26/082; B23K 26/1462; B23K 26/36; B08B 13/00

(57) ABSTRACT

In a first aspect, the invention relates to a laser treatment head comprising an input for a laser bundle, and further provided with a lens system for focusing the laser bundle and a scanning system for deflecting the laser bundle according to a one-dimensional or two-dimensional touch pattern. In particular, the laser treatment head further comprises an directional body configurable relative to the casing between at least a first position and a second position, for variably emitting the deflected laser bundle with said touch pattern, in at least a first or a second emission direction. In further aspects, the invention relates to a laser treatment device and a laser treatment process.

### TECHNICAL FIELD

The invention relates to laser treatment of surfaces. In particular, the invention relates to laser cleaning equipment, to laser cleaning heads, and to methods for laser cleaning.

### BACKGROUND

Laser treatment and laser cleaning are in themselves known in the state-of-the-art.

As an example, CN 206661838 (Herolaser) describes a laser device for cleaning surfaces. The device consists of a laser source and a separate, portable laser head that is connected to the laser source. The laser head comprises a collimator and two movable mirrors. The movement of these mirrors is such that the collimated laser bundle scans the surface, through a field lens and an exit window with protective glass. The field lens and the protective glass are permanently mounted in the laser head, at an oblique angle. The field lens provides focus on the surface. The protective glass shields the field lens. An inclined angle of approx. 20° is considered optimal. The movable mirrors are then arranged accordingly.

Further, DE 20 2017 103 770 (4JET) describes another portable laser cleaning head for delivering a pulsed laser bundle. Here too, the laser bundle is emitted at an oblique angle, seen with respect to the axis of the laser cleaning device. Preferably, this is an oblique angle of approximately 50°.

Some important properties of laser cleaning and laser cleaning equipment are its effectiveness, capacity and speed, as well as its autonomy, manoeuvrability, user-friendliness and ergonomics. Special attention is paid to maximum safety for the user.

A shortcoming of existing laser cleaning equipment is the limited manoeuvrability of the laser head. Furthermore, existing laser heads often have a field lens mounted at the front of the laser head. Such lenses are heavy and expensive. Moreover, they are vulnerable, close to the surface to be cleaned, where all kinds of contaminants are released. It is therefore preferable to have a protective glass in between.

KR 2011 0032992 describes a trimming device for a plastic inner panel for a refrigerator.

DE 10 2010 026107 unveils a device and a process for gas-assisted machining of workpieces with energetic radiation.

The present invention envisages an improved laser treatment device, and an improved method of laser treatment. Thereby, a solution is provided for at least one of the above-mentioned problems.

### SUMMARY OF THE INVENTION

To this end, the invention provides in a first aspect a laser treatment head according to claim 1, for treating surfaces. In particular, the laser head comprises a directional body which is configurable relative to the casing in at least two different positions. Thus, the laser bundle, already scanning according to a one-dimensional or two-dimensional touch pattern, is additionally directed according to a direction of emission that corresponds to the selected position of the directional body.

The variable emission direction ensures much greater manoeuvrability of the laser treatment head. The laser head and the laser source connected to it are thus much more versatile, on a wide range of surfaces, and much less restricted by surface geometry.

In a preferred embodiment according to claim 8, the directional body is rotatable over a range of at least 90°. Hereby it is possible to vary the direction of emission within a range of at least 90°.

In further aspects, the invention provides a laser treatment device with a laser head and a laser source, and a method for laser treatment.

### DESCRIPTION OF THE FIGURES

FIGS. 1-3 show a laser treatment head according to a possible embodiment of the invention, each time from a different perspective and with the directional body configured in a first position or a second position, respectively.

FIG. 4 shows an exposed laser treatment head, according to a possible embodiment of the invention. The directional body is not shown here.

FIG. 5 shows a laser head according to another possible design. Optionally, the interior is similar to that in FIG. 4.

FIG. 6 shows the part of a laser treatment device which includes the laser source, according to a possible embodiment of the invention.

### DETAILED DESCRIPTION

The invention relates to a laser treatment head, a laser treatment device, and a process for laser treatment of surfaces, for example for laser cleaning.

Unless otherwise defined, all terms used in the description of the invention, including technical and scientific terms, have the meaning generally understood by those skilled in the technical field of the invention. For a better assessment of the description of the invention, the following terms are explained explicitly.

In this document, “a”, “the” and “it” refer to both the singular and the plural unless the context clearly indicates otherwise. For example, “a segment” means one or more than one segment.

When “approximately” or “round” is used in this document with respect to a measurable quantity, a parameter, a time or moment, and the like, variations are meant of +/−20% or less, preferably +/−10% or less, more preferably +/−5% or less, even more preferably +/−1% or less, and even more preferably +/−0.1% or less than and of the quoted value, insofar as such variations are applicable in the described invention. However, it should be understood that the value of the quantity where the term “about” or “around” is used is itself specifically disclosed.

The terms “comprise”, “comprising”, “consisting of”, “providing for”, “containing”, are synonyms and are inclusive or open terms indicating the presence of what follows, which do not exclude or prevent the presence of other components, characteristics, elements, members, steps, known from or described in the state of the art.

The quoting of numerical intervals through the endpoints comprises all integers, fractions and/or real numbers between the endpoints, these endpoints included.

In a first aspect, the invention relates to a laser treatment head comprising a casing having an input for a laser bundle, further provided with a lens system for focusing the laser bundle and a scanning system for deflecting the laser bundle according to a one-dimensional or two-dimensional touch pattern. In particular, the laser treatment head further comprises an directional body that is configurable relative to the casing between at least a first position and a second position, for variable sending the deflected laser bundle with said touch pattern, in a first output direction or a second output direction relative to the casing, respectively.

Preferably, the laser head can be connected to a laser source, for example using a fibre optic cable. Together, the laser head and the laser source form a laser treatment device (also called: laser device). Suitable lengths of such cables may vary from a few metres to several tens of metres. For the laser source itself, a choice can be made between a continuous laser source or a pulsed laser source. Some suitable emitting powers of pulsed laser sources are 100 W, 500 W, 1000 W and more. The invention is not limited to any of these.

A known application for laser treatment equipment is the removal of coatings, rust, varnish and/or contamination from surfaces. Optionally, the invention relates particularly to laser cleaning, for cleaning surfaces. That is, for removing a surface contamination from a surface. However, the invention is generally not limited to this.

Laser treatment heads or laser cleaning heads according to the present invention can be either portable/mobile or fixed mounted. Portable laser heads can be guided by an operator by hand. Alternatively, a portable laser head may be mounted to a robotic arm. An advantage of portable laser heads is their improved maneuverability. Preferably, a portable laser head has at least one mounting point for attaching a handle to the laser head and/or for attaching the laser head to a robot arm. Optionally, one or more handles of the laser head are removable, whereby the laser head can be mounted to a robot arm at the level of those mounting points.

Preferably, the laser device comprises a collimator for collimating the imported laser bundle. This is advantageous for further focusing and scanning. Preferably, the collimator is comprised by the laser head itself. However, this is not necessarily the case. Optionally, the collimator is equipped with an optical isolator, as known in the field. Optionally, the laser head comprises a thermally conductive structure that is tangential to the insulator and extends to an outer surface of the laser head for heat dissipation. For example, this may be a structure made of aluminium.

The said lens system may comprise one or more lenses, for focusing the laser bundle at the surface, and/or for shaping the laser bundle (e.g. from Gaussian to top-hat). A narrow focus with a high energy concentration may be necessary for some processes such as laser cleaning. However, a “focus at the surface” is generally understood herein to be a focus in the vicinity of the surface. It may be the deliberate intention of an operator to focus a certain distance in front of or beyond the surface. Suitable lens systems for focusing are known. In a preferred embodiment, the laser head provides a lens system with an adjustable focus, and preferably with an automatically adjustable focus (i.e. an autofocus). An autofocus is particularly advantageous for worn laser heads. It provides a certain margin on the distance between the laser head and the surface to be treated/cleaned. The movement for the operator is thus less “strict”, with the focus being automatically corrected within a certain margin (e.g. based on time of flight distance sensor signals). Optionally, the margin is at least 0.5 cm, and preferably more than 0.5 cm, and further preferably more than 2.0 cm, for example about 5 cm.

The scanning system mentioned above deflects the laser bundle in at least one direction, according to a touch pattern. Optionally, it is a random touch pattern. Optionally, it is a non-random, predefined touch pattern. A possible example of a one-dimensional pattern is a straight line movement of the focus back and forth on the surface. A possible example of a two-dimensional touch pattern is a meandering motion within a rectangular area on the surface. Optionally, that touch pattern can be a repetitive touch pattern. The touch pattern starts from the laser head itself; it deflects the laser bundle relative to the laser head. The fine laser bundle (e.g. 100 μm²) will thus “scan” a larger scanning area (e.g. 1 cm²) on the surface. In the process, its very high energy concentration is briefly administered at several successive points. This is known in principle for laser cleaning. The movement of the laser focus according to the scanning pattern is usually much faster than the movement of the laser head in relation to the surface, preferably at least one order of magnitude faster. Suitable scanning systems are known by the professional. Optionally, the laser head comprises two rotatable scanning mirrors. Optionally, these are controlled via corresponding galvanometers.

Now, the laser treatment head further comprises a directional body that is configurable relative to the casing between at least a first position and a second position. The term “position” herein refers to a combination of the position and orientation of the target with respect to the casing. The term “configurable” means that the directional body can assume at least those positions. In a possible, non-exhaustive implementation form, the first position is a forward position and the second position is a downward position. Furthermore, the position of the directional body determines the final emission direction for the laser bundle, according to the created touch pattern. Consequently, the current laser head has much greater maneuverability. Depending on the position of the target, the laser bundle can be directed either in a forward or in a downward direction. For example, in terms of ergonomics, the forward position is preferable for vertical surfaces, and the downward position is preferable for horizontal surfaces. However, the invention is not limited to this.

Optionally, the directional body can be mounted permanently on the casing in at least the first position and in the second position. In this case, the scan pattern is emitting accordingly, in the first or the second emission direction respectively. Alternatively, the directional body can be moved freely between the first and second positions. Alternatively, the directional body can be moved freely between the first and second positions. Optionally, the directional body is moved manually between the said positions. Alternatively, this movement is automatically controlled, based on sensors. This mechanism (e.g. with automatic levelling) is described in more detail below.

In a further or alternative embodiment, the directional body forms an exit window which is preferably fitted with a protective glass. The exit window is a fixed part of the target. As an advantage, it is therefore automatically aligned according to the general direction of emission for the scan pattern.

In a further or alternative embodiment, the directional body comprises a mirror surface for mirroring and directing the deflected laser bundle. Preferably, the mirror surface can assume different positions, whereby the scan pattern is emitted in a corresponding direction. The position of the mirror surface determines the direction of emission.

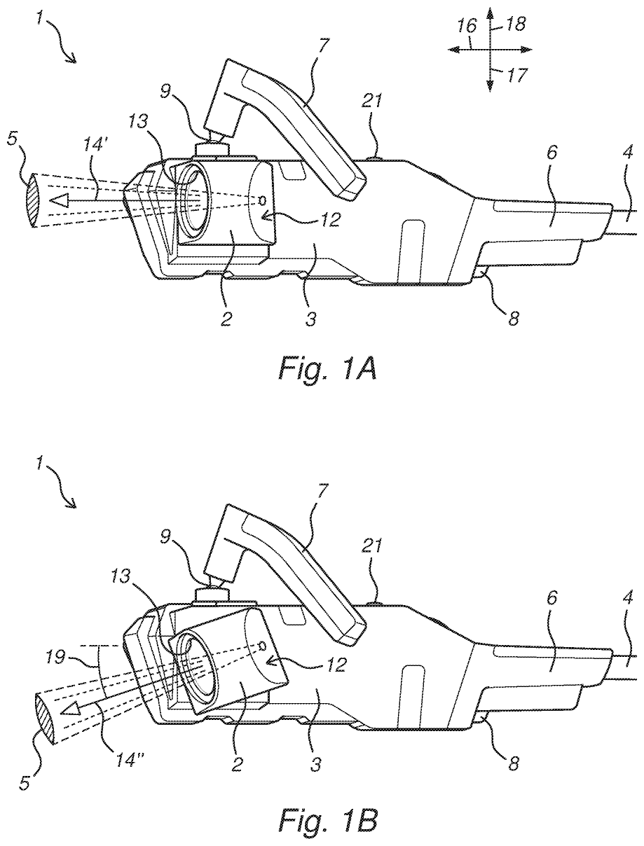

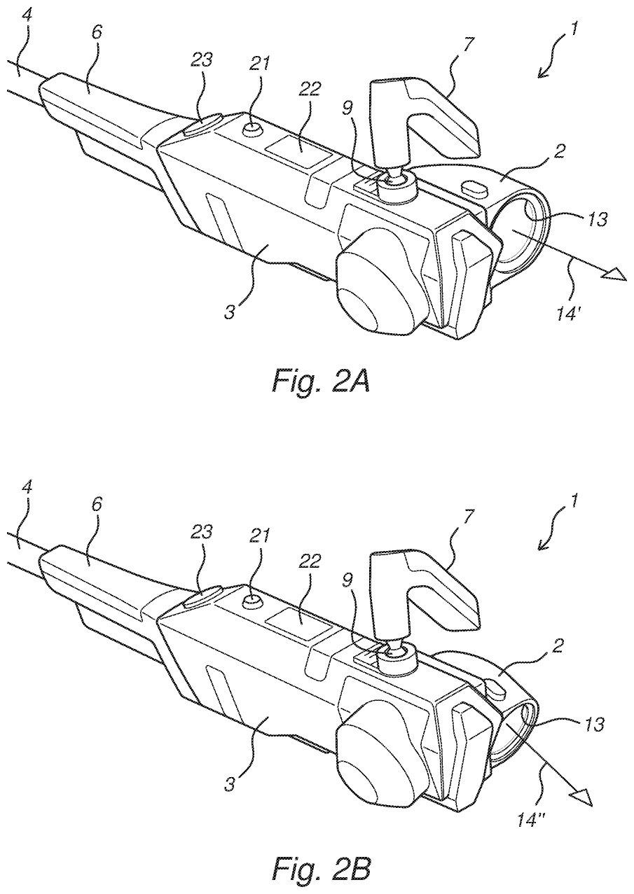

In a further or alternative embodiment, the directing device is rotatable between the mentioned positions, around a rotation axis. Preferably, the directional body is continuously rotatable within a certain range. Preferably, the rotation axis intersects the mirror surface obliquely. In further preference, the rotation axis makes an angle of about 45° with the mirror surface. As shown in the embodiment of FIGS. 1-3, a scan pattern in the (originally) lateral direction can be emitting variable in the upward, forward, and downward directions by mirroring with the directional body. For this purpose, the′ target is rotated around a lateral rotation axis.

By further preference, the mirror surface is arranged to receive the laser bundle from the casing, essentially parallel to the rotation axis. Thus, regardless of the rotational position of the mirror surface, the scanning pattern will always be incident diagonally, at an angle of approximately 45°.

In a further or alternative embodiment, the directional body is rotatable over a range of at least 90°, preferably over a range of more than 90°. According to a preferred embodiment, the directional body also allows at least one position in an oblique upward direction, for obliquely emitting the scan pattern. This is advantageous for cleaning, for example, ceiling surfaces/surfaces located above the head.

In one possible embodiment, the laser head or the laser device comprises a computer control for automatically controlling the movement or rotation of the target. Therewith the emission direction of the touch pattern is thus automatically configured.

In such an automated configuration of the emission direction, the movement of the laser focus is determined by several contributions. A first contribution is the “scanning movement” of the laser focus according to the touch pattern, controlled from the scanning system. A second contribution is the “aiming movement” of the touch pattern as a whole, through automatic configuration of the directional body. A third contribution is the “carrier movement” of the laser head as a whole, relative to the surface. As mentioned above, the “scanning movement” of the laser focus, in the form of the touch pattern, is an extremely fast and continuous movement. Preferably, the “aiming movement” due to the directional body only causes a shift of this touch pattern at the surface, with a slower speed. Preferably at least one order of magnitude slower. Typically, the scanning movement is a periodic movement. This is not necessarily the case for the directional movement.

In a further or alternative embodiment, the laser head is equipped with at least one sensor for measuring a sensor signal associated with a position (e.g., a distance), an orientation, a speed and/or an acceleration of the laser treatment head relative to the surface. In addition, the laser head comprises a control for automatically configuring the target between the aforementioned positions, based on the sensor signals. This general principle allows for motion stabilisation. According to a possible example, the orientation of the laser head in relation to the surface is continuously monitored. If the laser head is not held parallel to the surface (or not at the desired angle), the emission direction is adjusted accordingly; the directional body automatically rotates to an adjusted position to compensate. There is thus an automatic levelling function.

Another stabilising mechanism is the autofocus. According to a possible example, the distance between the laser head and (the focus location at) the surface is continuously monitored. Based on this, the focus distance is changed, within a margin of 5 cm. This always ensures the desired focus of the laser bundle on the surface. Optionally, the lens system comprises another means of adjusting the focus diameter, e.g. before focusing. This allows the intensity of the focus on the surface to be changed.

In a further or alternative embodiment, the laser treatment head comprises one or more surface sensors, illuminators, extractors and/or spacers mounted on the target. The advantage is that these are automatically aligned with the target, in its various positions. Optionally, the laser head is equipped with one or more surface sensors that identify the released contaminants in real time.

Optionally, the laser head comprises a range finder, preferably configured to determine a distance to the surface according to the emission direction of the scan pattern. The laser head is switched off, both when a too short distance and a too long distance is registered. The threshold values are set accordingly. Too short a distance (e.g. <20 cm) can damage the system by laser bundles reflecting back into the laser head and/or by all kinds of dirt being thrown up. Too great a distance (e.g. >50 cm) indicates that the laser head is not directed at the surface to be cleaned. Switching on is unsafe in this situation. In a possible embodiment, the laser head is automatically switched off upon detection of a distance greater than 110% of the focus distance. In a further or alternative embodiment, the laser head is automatically switched off upon detection of a distance smaller than 90% of the focus distance. “Focus distance” refers to the focus distance of the lens or lens group currently active (see below).

Optionally, the laser head provides visual feedback to the operator via a projection on the surface to be cleaned. For example, relevant information is projected onto the surface by means of a red laser. Optionally, the laser head provides haptic feedback to the operator, by means of one or more vibration signals. Preferably, the vibration signals are generated in the vicinity of one or more handles. Visual and haptic feedback can be informative, alarming and/or guiding.

In a further or alternative embodiment, the lens system comprises a revolving filter wheel (also known as a carousel system or revolving system) with at least two lenses or lens groups. A “lens group” comprises one or more consecutive lenses that optically influence the laser bundle. By turning the filter wheel, the desired lens or lens group can be selected. An important advantage is that the lenses can be changed much more easily. It is not necessary to open up the optics for this purpose. There is thus less risk of contamination of the lenses. Optionally, the filter wheel is driven by a DC motor. Alternatively, the filter wheel can be adjusted manually. Optionally, the filter wheel can move forward-backward, for autofocus.

Preferably, the filter wheel comprises several smaller lenses. Optionally, the filter wheel is positioned between the collimator and the scanning system. Smaller lenses are individually more compact, lighter and cheaper. Also, this position of the filter wheel at the back of the laser head, near the laser feed, is ergonomically preferable. The weight of the laser head is then better balanced. Optionally, the filter wheel comprises in at least one position a converter from a Gaussian laser profile to a tophat laser profile. Optionally, the filter wheel comprises at least two lens groups with different focus distances. Preferably, the laser head comprises means (e.g., a potentiometer) for registering the rotational position of the filter wheel. Thus, the laser head knows which lens group is active, and what the current focus distance is. An automatic adjustment of the aforementioned threshold values for minimum distance and maximum distance follows, at which point the laser device is switched off.

In a second aspect, the invention relates to a laser treatment device (=laser device) comprising a laser source adapted for emitting a laser bundle, and further comprising a portable laser treatment head in accordance with one of the preceding claims, which laser treatment head is operatively connected to the laser source. The same features can be reproduced, and the same advantages can be repeated.

In a third aspect, the invention relates to a process for treating a surface by means of a laser bundle, comprising:
generating a laser bundle,
focusing the laser bundle, and
deflecting the laser bundle according to a one-dimensional or two-dimensional touch pattern,

In particular, the deflected laser bundle is additionally mirrored according to a configurable beam direction. Optionally, the deflected laser bundle (with scan pattern) is additionally mirrored on a configurable mirror surface, for directing that scan pattern. Optionally, the process is performed using the laser head described above.

In a further or alternative embodiment, the method comprises collecting a sensor signal associated with a position, an orientation, a speed and/or an acceleration of the laser treatment head relative to the surface, and configuring the emission direction based on the sensor signal.

In a further or alternative implementation, the touch pattern is compensated for by the emission direction that is configured. Reference is made to the description of the figures.

In what follows, the invention is described by means of non-limiting examples and figures illustrating the invention, which are not intended or should be interpreted as limiting the scope of the invention.

FIGS. 1-3 show a laser treatment head 1 according to a possible implementation form, in each case from a different perspective and with the directional body 2 configured in a first position A or a second position B respectively. The laser head 1 comprises a casing 3 with an input 4 for laser radiation 5. For example, this is an input for a fibre optic cable, operatively connected to a laser source 10. FIGS. 1-3 show only the laser head 1.

The casing 3 of the laser head 1 comprises means for focusing and deflecting the input laser bundle 5, to a one-dimensional or two-dimensional touch pattern. Although these means are not visible in FIGS. 1-3. Furthermore, the casing 3 is provided with a rear handle 6 and a front handle 7. The laser head 1 can thus be gripped with two hands, for stable use. The rear handle 6 is provided around the laser input 4. It has an actuator 8 at the bottom for activating the laser head 1. When activated, the actuator 8 is preferably flush with the surface of the handle 6. Furthermore, the actuator 8 is enclosed in an angular shape. This reduces the risk of accidental activation. The front handle 7 is mounted on the casing 3 by means of a ball joint 9. It is thus adjustable, which contributes to its maneuverability and ergonomics. Preferably, the front handle 7 can also be locked in a selected position/orientation.

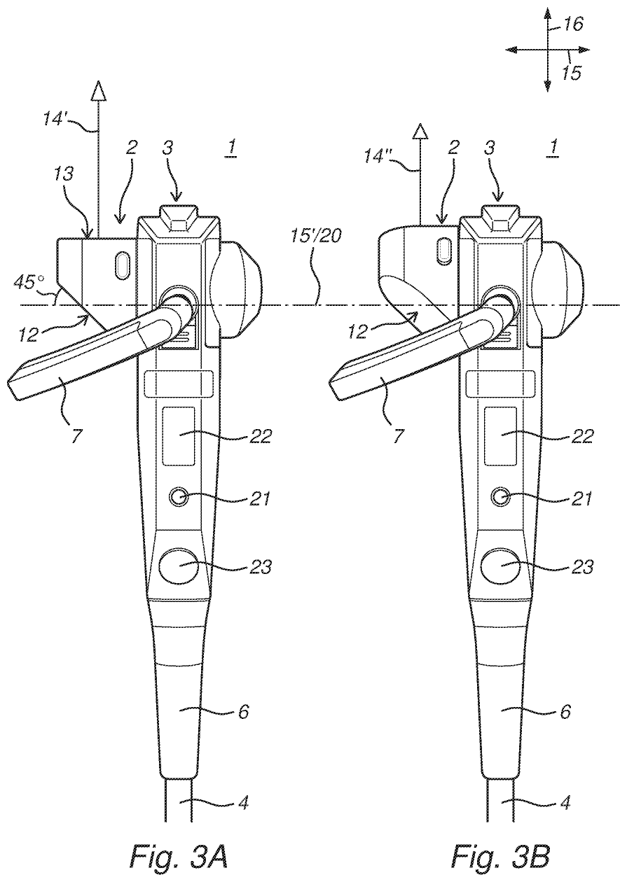

Initially, the formed touch pattern of the laser bundle 5 is directed laterally, out of the casing 3. This lateral direction 15′ is also shown in FIG. 3A-B. The directional body 2 of the laser head 1 now provides an inclined mirror surface 12, at an angle of approximately 45° to the lateral direction 15′. In FIGS. 1-3, the mirror surface 12 is referred to as the rear face of the focusing device 2. However, the skilled person will understand that it is an internal mirror surface 12, extending against and along this rear face. In general, the laser head 1 is by no means limited to this design. The touch pattern is mirrored against the mirror surface 12, changing direction in the process. Finally, the scanning pattern leaves the laser head 1 through the exit window 13 of the directional body 2, in a so-called emission direction 14. In particular, the emission direction 14 differs depending on the position A, B of the directing device 2. In FIG. 1A-3A, for example, the touch pattern is emitted in a forward direction 16. In FIG. 1B-3B the touch pattern is emitted diagonally downward, at an angle 19 to the forward direction 16.

Preferably, the directing device 2 can assume a plurality of different positions A, B. For example, the directional body 2 is rotatable to this end, about a rotational axis 20. In FIGS. 1-3, the rotational axis 20 coincides with the aforementioned lateral direction 15′. Preferably, the directional body 2 is continuously rotatable within a range of more than 90°, for example within a range of about 115°. The emission direction 14 is then continuously configurable over the same range. Preferably, the range covers at least one inclined upward and one inclined downward emission direction 14, viewed relative to the casing 3. This provides greater maneuverability of the laser head 2.

An important advantage is that the laser bundle 5 (with predefined touch pattern) can be flexibly directed to the surface 11 to be cleaned, by rotating the target 2. Preferably, the directional body 2 may also be fixed in a desired position A, B. Optionally, the rotation of the directional body 2 is automatically controlled. For example, it is possible to equip the laser cleaning head 2 with one or more sensors for measuring an orientation of relative to the surface to be treated 11. When the laser cleaning head 2 is moved manually along the surface 11, the directional body 2 automatically rotates (on control of a motor—not shown). In doing so, an optimum angle of incidence for the scanning pattern is achieved. This principle is also referred to as “autoleveling” or “automatic levelling”. The invention is not limited to this. Optionally, the directional body 2 can be automatically controlled based on a measured position, orientation and/or speed of the laser head 1 relative to the surface to be cleaned 11.

Optionally, the laser cleaning head 1 provides a number of additional functionalities such as an emergency stop/emergency button 21, a display 22 for visual feedback and/or a control panel 23 for changing one or more treatment parameters. Optionally, one or more engagement surfaces on the casing 3 of the laser cleaning head 1 are covered with a thermoplastic elastomer (TPE).

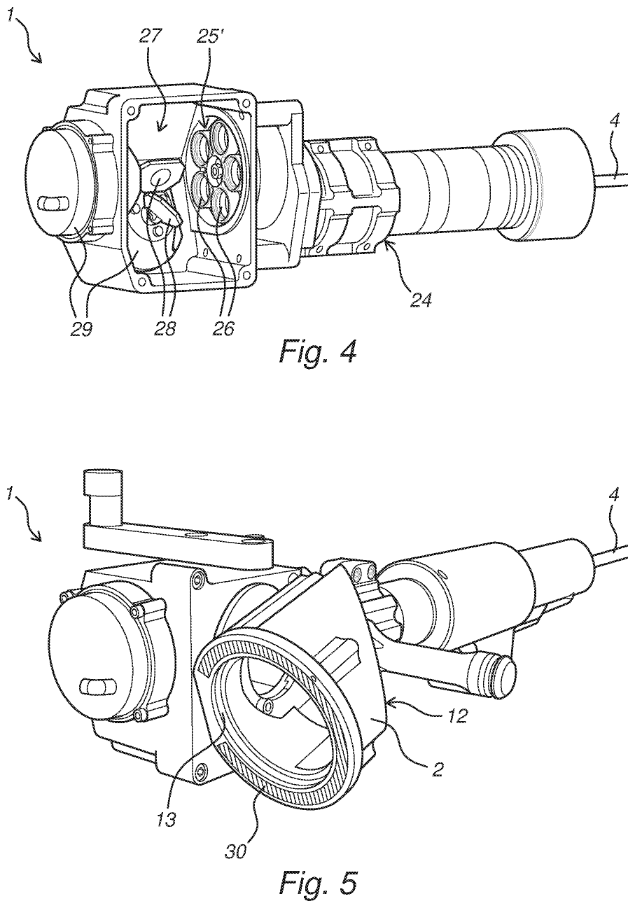

FIG. 4 shows an exposed laser treatment head 1, according to a possible embodiment of the invention. The laser head 1 shown provides a collimator 24 for collimating the input laser bundle 5. Subsequently, the laser bundle 5 passes through a lens system 25 and then a scanning system 27. The directional body 2 is not shown in FIG. 4.

The lens system 25 provides focus on the surface to be treated 11. In FIG. 4, the lens system 25 comprises a filter wheel 25′ with a set of five different lenses and/or lens groups 26. Each corresponds to a well-defined set of optical properties (e.g., a well-defined focus distance, a conversion from a Gaussian to a tophat laser profile, etc.).)

The filter wheel 25′ allows easy changing of the lenses 26, without having to open the laser head 1 for this purpose.

The scanning system 27 deflects the laser bundle 5 into a one-dimensional or two-dimensional touch pattern, as known in laser treatment and laser cleaning. Optionally, the scanning system 27 deflects the laser bundle 5 in a line shape (i.e., one-dimensionally). In the embodiment shown, the scanning system 27 for this purpose comprises two rotatable mirrors 28 that are rotatable with respect to mutually orthogonal axes of rotation. The mirrors 28 are essentially parallel to the corresponding axes of rotation. They enable deflection of the laser bundle 5 in two different spatial directions, independently of each other. The rotation of such a mirror 28 is controlled by an associated motor 29.

The target 2 is not shown in FIG. 4. Finally, the position of this target 2 will determine the emission direction 14 for the laser bundle 5 (according to the formed touch pattern). It is obvious that this emission direction 14 also influences the projection onto the surface 11. For example, a square touch pattern in the downward direction 17 will again produce a square projection on a horizontal surface 11. In oblique forward direction 16, however, it will create an enlarged, rectangular projection. Optionally, the touch pattern can be compensated for this in advance. For example, it is possible to generate a narrowed rectangular touch pattern, which is transmitted obliquely forward and gives rise to a desired square projection on the surface 11. Optionally, the intensity of the laser bundle 5 is also adjusted, as described above. Preferably, such compensation is provided by the scanning system 27. Of course, the invention is generally not limited to square and/or rectangular scanning patterns.

FIG. 5 shows a laser head 1 according to another possible design. Optionally, the interior is similar to that of FIG. 4. Thus, with a collimator 24, a lens system 25 and a scanning system 27. FIG. 5 further shows the directional body 2. At the rear, the directional body 2 is again provided with an inclined mirror surface 12. Optionally, the front facing directional body 2 is provided with illumination means 30. For example, this involves a pair of LEDs arranged in an annular fashion around the emitting window 13. Advantageously, such LEDs are automatically oriented according to the emission direction 14 of the laser bundle 5, independent of the position A, B of the directional body 2.

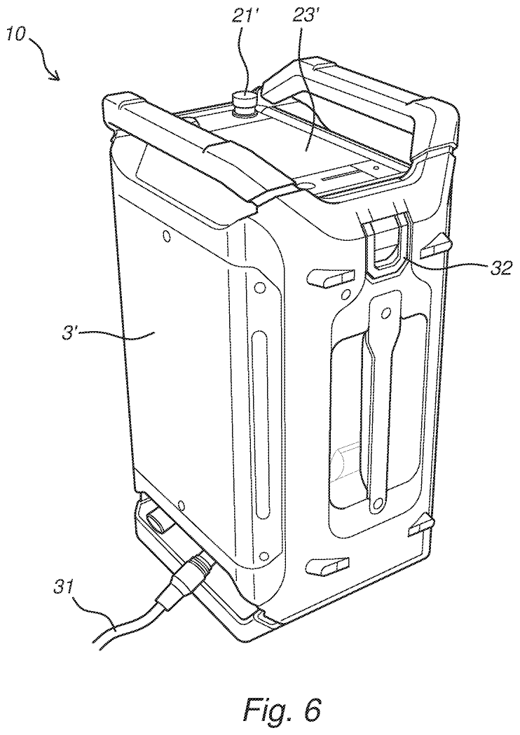

FIG. 6 shows the portion of the laser treatment device 1, 10 that encloses, inter alia, the laser source, according to a possible embodiment of the invention. Herein also referred to in its entirety as “laser source” 10. Preferably, this portion comprises a casing 3′ made of a lightweight, carbon fiber-reinforced plastic material. Preferably, it is further provided with at least one lifting ring 32 that can be rotated between a collapsed position (see FIG. 6) and an operative position. The laser source 10 also provides an emergency stop 21′, a control panel 23′ and a connection for a fiber optic cable 31. Preferably, the laser source 10 is also provided with all kinds of electronics, controls, and optionally also an air cooling or water cooling system.

Example: Laser treatment device specifications—According to a possible implementation form, the laser treatment device is dust and splash water resistant, at least according to the IP53 standard. Optionally, it can be used in an explosive atmosphere (e.g. ATEX type 1). The device can be stored at an ambient temperature of between minus 5° C. and plus 55° C., and it can be used at an ambient temperature of between 0° C. and 40° C. Preferably the device can withstand a relative humidity of 80% at 40° C., and 90% at 30° C.

Example 2: Weld tracing—According to one possible embodiment, the invention is used for weld cleaning. The idea is to only scan (an area of) the weld by means of the laser. Optionally, the laser follows a back and forth scanning pattern, athwart to the weld. The laser head itself is moved along the weld by a user. Preferably, the laser head is provided with a set of sensors that is able to recognise the weld at the surface, and to determine the distance to the weld and the speed of the laser head, for example via time-of-flight distance meters and accelerometers. A deviation in y-direction (transverse to the weld) is compensated by the scanning system. The margin for this can be, for example, 3 cm. A deviation in x-direction (along the welding seam) is compensated by the targeting system. The margin for this for the emission direction can be, for example, 30° to 40°. Meanwhile, the desired focus is continuously maintained on the surface, via the autofocus lens system. The focus intensity can also be changed, via a mechanism that adjusts the beam waist. Movement too fast or too slow along the weld, and deviations in y-position and z-position are communicated to the user. In this way, the margins are not exceeded.

The numbered elements on the figures are:
1 Laser treatment head (=laser head)
2 Directional body
A First position
B Second position
3 Casing
4 Input
5 Laser bundle (according to touch pattern)
6 Rear handle
7 Front handle
8 Actuator
9 Ball joint
10 Laser source
11 Surface (to be treated)
12 Mirror surface
13 Exit window
14 Emmission direction
15 Lateral direction
16 Forward direction
17 Downward direction
18 Upward direction
19 Corner
20 Rotational axis
21 Emergency stop/emergency button
22 Display
23 Control panel
24 Collimator
25 Lens system
26 Lens or lens group
27 Scanning system
28 Twistable mirror
29 Engine
30 Illuminants
31 Cable
32 Lifting ring

It is assumed that the present invention is not limited to the forms of implementation described above and that some modifications or changes may be added to the examples and figures described, without revaluing the added claims.

1. A laser treatment head (1) comprising a casing (3) with an input (4) for a laser bundle (5), further provided with a lens system (25) for focusing the laser bundle (5) and a scanning system (27) for deflecting the laser bundle (5) according to a one-dimensional or two-dimensional touch pattern, having the feature that the laser treatment head (1) further comprises a directional body (2) configurable in relation to the casing (3) between at least a first position (A) and a second position (B) for variably deflecting the laser bundle (5) according to the said touch pattern in a first emission direction (14′) and a second emission direction (14″), respectively, relative to the casing (3).

2. The laser treatment head (1) according to claim 1, whereby the directional body (2) forms an exit window (13).

3. The laser treatment head (1) according to claim 1, whereby the directional body (2) is configurable between at least a first forward position (A) and a second downward position (B).

4. The laser treatment head (1) according to claim 3, whereby the directional body (2) comprises a mirror surface (12), for mirroring and aiming the deflected laser bundle (5) with the aforementioned touch pattern.

5. The laser treatment head (1) according to claim 4, whereby the directional body (2) is rotatable between said first forward position (A) and said second downward position (B), around a rotation axis (20).

6. The laser treatment head (1) according to preceding claim 5, whereby the rotation axis (20) cuts the mirror surface (12) obliquely, preferably at an angle of 45°.

7. The laser treatment head (1) according to claim 5, whereby the mirror surface (12) is arranged to receive the laser bundle (5) from the casing (3), essentially parallel to the rotation axis (20).

8. The laser treatment head (1) according to claim 5, whereby the directional body (2) is rotatable over a range of at least 90°, preferably over a range of more than 90°.

9. The laser treatment head (1) according to claim 3, wherein the laser treatment head (1) is equipped with at least one sensor for measuring a sensor signal that is related to a position, an orientation, a speed and/or an acceleration of the laser treatment head (1) with respect to a surface (11) to be cleaned, and further comprising a control for automatic configuration of the directional body (2) between said first forward position (A) and said second downward position (B), based on the sensor signals.

10. The laser treatment head (1) according to claim 1, further comprising one or more surface sensors, illuminators (30), extractors and/or spacers mounted on the directional body (2), and directed according to the directional body (2).

11. The laser treatment head (1) according to claim 1, wherein the lens system (25) comprises a filter wheel (25′) with at least two lens groups (26).

12. A laser treatment device (1, 10) comprising a laser source (10) adapted for emitting a laser bundle (5), and further comprising a portable laser treatment head (1) in accordance with claim 1, which laser treatment head (1) is operatively connected to the laser source (10).

13. A process for treating a surface (11) by means of a laser bundle (5), comprising:
the generation of a laser bundle (5),
focusing the laser bundle (5), and
deflecting the laser bundle (5) according to a one-dimensional or two-dimensional touch pattern,
with the characteristic that the deflected laser bundle (5) with the above-mentioned touch pattern is emitted by means of a further mirroring in a configurable emission direction (14).

14. The process according to claim 13, further comprising collecting a sensor signal associated with a position, an orientation, a speed and/or an acceleration of the laser treatment head (1) relative to the surface (11), and configuring the emission direction (14) based on the sensor signal.

15. The process according to claim 13, whereby the touch pattern is compensated for the configured emission direction (14).
